(19) United States
(12) Patent Application Publication
(10) Pub. No.: US 2004/0107913 A1
(43) Pub. Date: Jun. 10, 2004

(54) A DEVICE FOR AND A METHOD OF MONITORING THE CLEANING OF A MILK LINE

(75) Inventors: AALZE VEENSTRA, GOUDA (NL); RENATUS IGNATIUS FRANSEN, VLAARDINGEN (NL)

Correspondence Address: HOWREY SIMON ARNOLD & WHITE, CITYPOINT, ONE ROPEMAKER STREET, LONDON, EC2Y 9HS, GB

(73) Assignee: LELY ENTERPRISES AG, ZUG (CH)

(21) Appl. No.: 10/604,619

(22) Filed: Aug. 5, 2003

(30) Foreign Application Priority Data
Aug. 6, 2002 (NL) 1021218
Sep. 11, 2002 (NL) 1021431

(51) Int. Cl. A01J 5/04

(52) U.S. Cl. 119/14.51

(57) ABSTRACT

A device for monitoring the cleaning of a milk line during a cleaning cycle is disclosed. The device is provided with a monitoring-unit comprising a computer and a memory for storing data at least temporarily, with a thermometer for measuring the temperature of a fluid that is present or has been present in the milk line and for supplying to the monitoring-unit a temperature signal that is indicative of the measured temperature, and with a comparing device for determining whether the measured temperature is higher than a predetermined threshold temperature, the comparing device being suitable for determining the first point of time when the measured temperature has come above the threshold temperature for the first time during a cleaning cycle, and for determining the last point of time when the measured temperature has come above the threshold temperature for the last time during the same cleaning cycle.

### CROSS REFERENCE TO RELATED APPLICATIONS

This application claims priority from Dutch patent applications no. 1021218 filed 6 Aug. 2002 and no. 1021431 filed 11 Sep. 2002, the contents of which are hereby incorporated by reference in their entirety.

### BACKGROUND OF INVENTION

1. Field of Invention

The invention relates to a device for monitoring the cleaning of a milk line. It further relates to a method of monitoring the cleaning of a milk line.

2. Description of the Related Art

Devices are known which are programmed in such a way that it can be assumed that the cleaning of the milk line has been performed correctly when the temperature has constantly been above for example approximately 40° C. during the main cleaning phase. However, it has been found that not only many incorrect alarms are generated, but that also in some cases it is impossible to take a correct decision as to whether or not the cleaning of the milk line has been performed properly.

### SUMMARY OF INVENTION

According to the present invention, a device for monitoring the cleaning of a milk line is provided, by means of which the above-mentioned drawbacks are at least partially overcome.

For this purpose the invention provides a device for monitoring the cleaning of a milk line during a cleaning cycle. The device comprises a monitoring-unit comprising a computer and a memory for storing data at least temporarily, a thermometer for measuring the temperature of a fluid that is present or has been present in the milk line and for supplying to the monitoring-unit a temperature signal that is indicative of the measured temperature and a comparing device for determining whether the measured temperature is higher than a predetermined threshold temperature. The comparing device determines the first point of time when the measured temperature has come above the threshold temperature for the first time during a cleaning cycle, and determines the last point of time when the measured temperature has come above the threshold temperature for the last time during the same cleaning cycle. In this manner it is possible to check the cleaning only after the last point of time, so that no alarms are triggered between the first and the last point of time, thus preventing many incorrect alarms.

For providing a sufficient indication as to whether the cleaning has been performed correctly, in an embodiment of a device according to the invention the comparing device is suitable for determining the highest temperature between the first and the last point of time. Additionally or alternatively the comparing device is suitable for determining the average temperature between the first and the last point of time.

A particularly accurate indication of the degree of cleaning is obtained if the comparing device is suitable for determining whether the measured temperature between the first and the last point of time at least equals a second threshold temperature during a minimum, predetermined uninterrupted period of time.

The thermometer may also be used for monitoring the pre-rinsing phase and the post-rinsing phase of the cleaning of a milk line.

In an embodiment of a device according to the invention the device may be provided with a conductivity meter for measuring the conductivity of a fluid that is present or has been present in the milk line. As the conductivity of the cleaning fluid often differs from the conductivity of the milk, the conductivity, or another electrical parameter, can be used for monitoring the cleaning. In this case too a comparison may be made with reference values for the conductivity.

In a further embodiment of a device according to the invention the device may be provided with a meter for measuring an optical parameter, in particular a color meter for measuring the color and/or the intensity of a color band of a fluid that is present or has been present in the milk line. As the color and/or the intensity of certain color bands of the cleaning fluid often differ(s) from the color and/or the intensity of the milk, the color can be used for an additional monitoring of the cleaning. Also in this case there can be made a comparison with reference values for the color.

According to a further aspect of the invention, an alarm device may be operated by the comparing device, whereby in cases of alarm it is possible for example to inform a supervisor about the situation.

The invention also relates to a method of monitoring the cleaning of a milk line during a cleaning cycle. The method comprises measuring the temperature of a fluid that is present or has been present in the milk line, determining whether the measured temperature is higher than a predetermined threshold temperature, determining a first point of time when the measured temperature has come above the threshold temperature for the first time during a cleaning cycle and determining a last point of time when the measured temperature has come above the threshold temperature for the last time during the same cleaning cycle. According to an advantageous embodiment, the method may determine the highest temperature between the first and the last point of time. Alternatively or additionally, it may determine the average temperature between the first and the last point of time.

In a particularly advantageous embodiment, the method may further determine whether the measured temperature between the first and the last point of time at least equals a second threshold temperature during a minimum, predetermined uninterrupted period of time.

Preferably, the method comprises the step of providing an alarm when the period of time between the first point of time and the last point of time is shorter than a predetermined threshold time. Alternatively, an alarm may be given when the maximum temperature is lower than a predetermined threshold top temperature and/or when the average temperature is lower than a predetermined average threshold temperature and/or when the temperature does not at least equal the second threshold temperature during the minimum, predetermined uninterrupted period of time.

In an alternative embodiment of the method there may be included a step of measuring conductivity or an optical parameter, in particular the color and/or the intensity, of a color band, of a fluid that is present or has been present in the milk line.

### BRIEF DESCRIPTION OF DRAWINGS

An embodiment of the invention will now be explained in further detail by way of example only with reference to the accompanying figures, in which:

FIG. 1 shows diagrammatically an embodiment of a device according to the invention; and

FIG. 2 shows diagrammatically a time graph of the temperature measured in the discharge line to the sewer.

### DETAILED DESCRIPTION

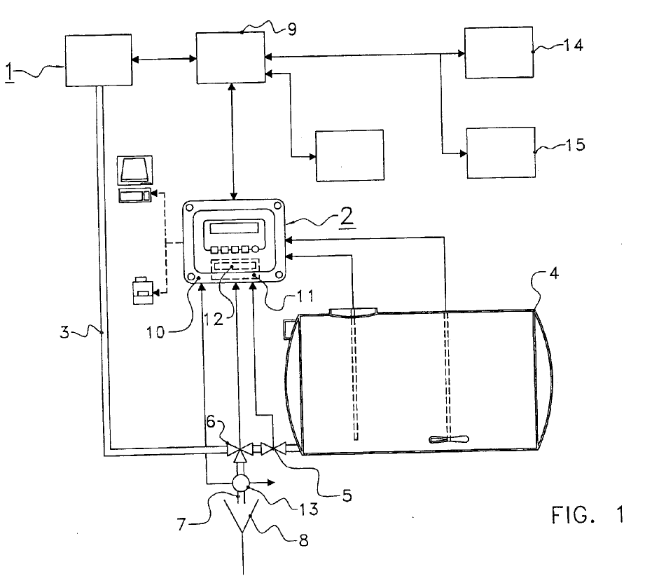

FIG. 1 shows diagrammatically an embodiment of an assembly of an automatic milking system 1 and a device 2 for monitoring the cleaning of a milk line 3 (also called supply line).

The automatic milking system 1 is connected to a milk tank 4 via the supply line 3. Via the supply line 3 it is possible to convey milk from the automatic milking system 1 to the milk tank 4 during the milking. There is disposed a valve, in particular a controlled valve 5, in the supply line 3 for the purpose of allowing, if desired, milk or another fluid, in particular a liquid, to flow into the milk tank 4.

It is known per se that the automatic milking system 1, in particular those components thereof that come directly into contact with milk, must be regularly cleaned. For this purpose a central cleaning system 9 may be used. Cleaning liquids (but also steam or another fluid) that have been passed from the central cleaning system 9 through the automatic milking system 1, are then discharged via said supply line 3. In the supply line 3 there is located a three-way valve, in particular a controlled three-way valve 6, to which is connected a discharge line 7 to a sewer 8 or the like. The valve 5 is then located between the three-way valve 6 and the milk tank 4.

The invention relates in particular to the device 2 for monitoring the cleaning of the milk line 3. For this purpose the device 2 comprises a monitoring-unit 10. The monitoring-unit 10 comprises a computer 11 and a memory 12 for storing data at least temporarily.

In the embodiment shown in FIG. 1 the monitoring-unit 10 further comprises a clock (not shown) for measuring time durations, which clock is integrated in the computer 11. In case of malfunction of the system the clock automatically continues to work with the aid of an emergency power supply and the points of time are at any rate stored in the memory.

The monitoring device 2 is further provided with a thermometer 13 for measuring the temperature of a fluid that is present in the discharge line 7. The thermometer 13 is suitable for supplying a temperature signal to the monitoring-unit 10, in particular the computer 11 thereof, which temperature signal is indicative of the temperature of the fluid present in the discharge line. The measured values of said thermometer 13 can then be used for monitoring the cleaning of the milk line 3.

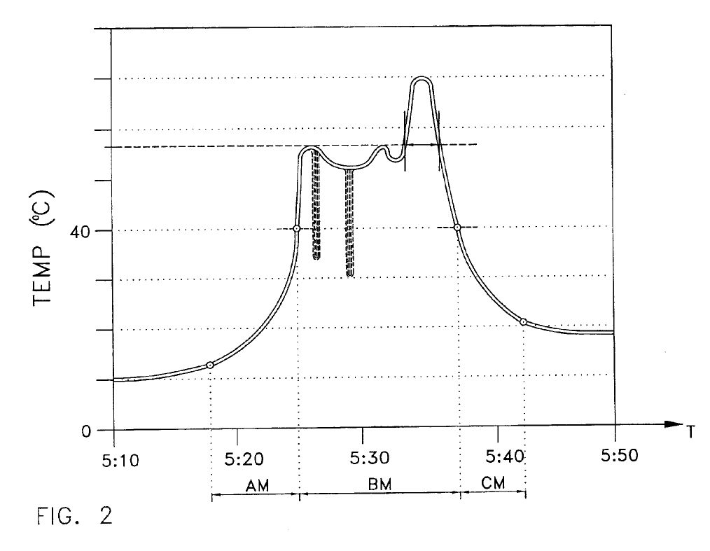

Such a cleaning is diagrammatically shown in the graph of FIG. 2. In the cleaning cycle a pre-rinsing phase AM, a main cleaning phase BM and a post-rinsing phase CM can be distinguished. It is usually assumed that the cleaning of the milk line has been performed correctly when the temperature has constantly been above for example approximately 40° C. (another threshold value is possible as well) during the main cleaning phase BM. Such simplified detection can also be performed by the device according to the invention. It has been found, however, that due to the fact that during the cleaning of the milk line the cleaning fluid, in particular the cleaning fluid that has been used during the main cleaning phase, is pulsated, the temperature may drop below the temperature threshold during the main cleaning phase BM (and then again rise to above the temperature threshold, as shown by the dashed lines). This not only leads to many incorrect alarms, but moreover it is impossible to take a correct decision as to whether or not the cleaning of the milk line has been performed properly.

In the monitoring device 2 according to the invention, incorrect messages are prevented by recording in the memory 12 of the computer 11 the first moment when the temperature has come above the threshold (for example 40° C.) and the last moment when the temperature has dropped below the threshold. The last moment may be determined for example by measuring, within a measuring-time duration after a moment when the temperature has come below the threshold, whether the temperature rises again to above the threshold. The measuring-time duration may be determined while taking into account the duration of the pulsations, and may have for example a value of twice (or a different multiple) the pulsation duration. The measuring-time duration may alternatively be a fixed time duration within which measurements take place. After it has been established that within the measuring-time duration the temperature has not returned to above the temperature threshold, it is established that the main cleaning phase BM has ended. Only at that moment the comparing device compares whether the temperature has met the predetermined threshold during the main cleaning phase BM. Thus many incorrect messages or alarms may be prevented. According to a feature of the invention a correct main cleaning may be deemed to have taken place if during the main cleaning phase the temperature of the main cleaning liquid has reached at least a minimum temperature value (for example 57° C.) during an uninterrupted time duration (for example 120 s). Of course, other thresholds may be applied as well.

The memory 12 is thus suitable for containing a lower threshold for the temperature of a fluid in the discharge line for the main cleaning phase. Furthermore, an upper threshold for the temperature in the pre-rinsing phase may also be included in the memory. Other thresholds may be applied as well.

The comparing device is capable of supplying an alarm signal to an alarm device 14, 15, as a result of which the alarm device 14, 15 can be operated. The alarm device may be a separate alarm device 14 or, in the case of an automatic milking system 1, the robot alarm device 15. The alarm device is then capable of giving for example a message to the mobile telephone of the supervisor, or a similar message.

Although the invention has been described with reference to an assembly comprising an automatic milking system, it will be obvious that the invention can also be applied to an assembly comprising a conventional or semi-automatic milking system. It will further be obvious that the thermometer can also be disposed in the milk line (supply line).

The monitoring device 2 shown in FIG. 1 comprises a comparing device which, in the embodiment shown, is integrated in the computer 11. Alternatively or additionally, a separate comparing device may be provided, which is suitable for determining the first point of time when the measured temperature has come above the threshold temperature (which can be set beforehand) for the first time during a cleaning cycle, and for determining the last point of time when the measured temperature has come above the threshold temperature for the last time during the same cleaning cycle. The comparing device can also be suitable for determining the highest temperature and/or the average temperature between the first and the last point of time.

The comparing device may further be suitable for determining whether the measured temperature between the first and the last point of time at least equals a second threshold temperature (which can be set beforehand and which is in particular higher than the first threshold temperature) during a minimum, predetermined uninterrupted period of time.

The invention also relates to a method of monitoring the cleaning of a milk line during a cleaning cycle. Said method comprises in particular the step of supplying an alarm in the following cases: when the period of time between the first point of time and the last point of time is lower than a predetermined threshold time; when the maximum temperature is lower than a predetermined threshold top temperature; when the average temperature is lower than a predetermined average threshold temperature; and/or when the temperature does not at least equal the second threshold temperature during the minimum, predetermined uninterrupted period of time.

Although the invention has been described with respect to the main cleaning, it will be obvious that the thermometer can also be used for monitoring the cleaning during the pre-rinsing phase AM and the post-rinsing phase CM. There may additionally be used a meter for measuring an electrical parameter, such as the conductivity, and/or a meter for measuring an optical parameter, such as the color, reflection, dispersion or absorption, for monitoring the cleaning. Said meters may be disposed for example in the same place as the thermometer.

Many modifications in addition to those described above may be made to the structures and techniques described herein with departing from the spirit and scope of the invention. Accordingly, although specific embodiments have been described, these are examples only and are not limiting upon the scope of the invention.

1. A device for monitoring the cleaning of a milk line during a cleaning cycle, the device comprising:
a monitoring-unit comprising a computer and a memory for at least temporarily storing data;
a thermometer for measuring the temperature of a fluid that is present or has been present in the milk line and for supplying to the monitoring-unit a temperature signal that is indicative of the measured temperature; and
a comparing device for determining whether the measured temperature is higher than a predetermined threshold temperature, the comparing device determining a first point of time when the measured temperature has come above the threshold temperature during a cleaning cycle, and determining a last point of time when the measured temperature has been above the threshold temperature during the same cleaning cycle.

2. The device as claimed in claim 1, wherein the comparing device determines a highest temperature between the first and the last point of time.

3. The device as claimed in claim 1, wherein the comparing device determines an average temperature between the first and the last point of time.

4. The device as claimed in claim 1, wherein the comparing device determines whether the measured temperature between the first and the last point of time at least equals a second threshold temperature during a minimum, predetermined uninterrupted period of time.

5. The device as claimed in claim 1, wherein the device is provided with a conductivity meter for measuring conductivity of a fluid that is present or has been present in the milk line.

6. The device as claimed in claim 1, wherein the device is provided with a meter for measuring an optical parameter of a fluid that is present or has been present in the milk line.

7. The device as claimed in claim 6, wherein the meter for measuring an optical parameter is a color meter for measuring the color or the intensity of a color band of a fluid that is present or has been present in the milk line.

8. The device as claimed in claim 1, wherein an alarm device can be operated by the comparing device.

9. A method of monitoring the cleaning of a milk line during a cleaning cycle, the method comprising:
measuring the temperature of a fluid that is present or has been present in the milk line;
determining whether the measured temperature is higher than a predetermined threshold temperature;
determining a first point of time when the measured temperature has come above the threshold temperature during a cleaning cycle; and
determining a last point of time when the measured temperature has been above the threshold temperature during the same cleaning cycle.

10. The method as claimed in claim 9, wherein the method further comprises determining a highest measured temperature between the first and the last point of time.

11. The method as claimed in claim 9, wherein the method further comprises determining an average measured temperature between the first and the last point of time.

12. The method as claimed in claim 9, wherein the method further comprises determining whether the measured temperature between the first and the last point of time at least equals a second threshold temperature during a minimum, predetermined uninterrupted period of time.

13. The method as claimed in claim 9, wherein the method further comprises giving an alarm when the period of time between the first point of time and the last point of time is shorter than a predetermined threshold time.

14. The method as claimed in claim 10, wherein the method further comprises giving an alarm when the highest measured temperature is lower than a predetermined threshold top temperature.

15. The method as claimed in claim 11, wherein the method further comprises giving an alarm when the average measured temperature is lower than a predetermined average threshold temperature.

16. The method as claimed in claim 12, wherein the method further comprises giving an alarm when the measured temperature does not at least equal the second threshold temperature during the minimum, predetermined uninterrupted period of time.

17. The method as claimed in claim 9, wherein the method further comprises measuring a conductivity of a fluid that is present or has been present in the milk line.

18. The method as claimed in claim 9, wherein the method further comprises measuring an optical parameter of a color band of a fluid that is present or has been present in the milk line.

19. The method as claimed in claim 18, wherein the optical parameter is the color or the intensity of the fluid.

20. The method as claimed in claim 9, wherein the last point of time is determined by measuring, within a measuring-time duration after a moment when the measured temperature has come below the threshold temperature, whether the measured temperature rises again to above the threshold temperature.
